(19) United States
(12) Patent Application Publication
(10) Pub. No.: US 2006/0061815 A1
(43) Pub. Date: Mar. 23, 2006

(54) Direct print system

(75) Inventor: Hiroshi Iwatani, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/229,703

(22) Filed: Sep. 20, 2005

(30) Foreign Application Priority Data
Sep. 21, 2004 (JP) 2004-273630

(51) Int. Cl. G06F 3/12

(52) U.S. Cl. 358/1.15

(57) ABSTRACT

In a direct print system comprised of a digital still camera and a photo-direct (PD) printer, it makes possible to confirm and change printing layout from the digital still camera so as to obtain a printing result satisfying a user's wish in multi-partitioned print that a plurality of images are printed on a paper sheet. Both of the digital still camera and the PD printer respectively have a decoder and an encoder for commands of PictBridge format, and both of the digital still camera and the PD printer can recognize predetermined comments written in comment lines of the PictBridge which are normally ignored. When the multi-partitioned print is selected by the user, commands appointing order of arrangement and directions of the images to be printed are written on the comment lines of the PictBridge and transmitted with a command of the PictBridge format for performing the multi-partitioned print from the digital still camera to the PD printer.

### BACKGROUND OF THE INVENTION

1. Field of the Invention

The present invention relates to a direct print system in which a digital still image data is directly transmitted from a digital still camera to a photo-direct printer for printing an image on a paper sheet.

2. Description of the Related Art

Recently, a direct print system, in which a digital still image data is directly transmitted from a digital still camera to a photo-direct printer (hereinafter abbreviated as PD printer) for printing an image, becomes popular. In such a direct print system, even when the digital still camera and the PD printer are products of different vendors, there is PictBridge as a technical standard to enable the direct print from the digital still camera to the PD printer. In the PictBridge technology, multi-partitioned print (layout print) can be performed for printing a plurality of images on a paper sheet, but printing layout format of the images in the multi-partitioned print is not established. Therefore, when a user chooses the multi-partitioned print in the PictBridge technology, it may occur that the multi-partitioned print is printed in a printing layout format different from the printing layout format that the user intended corresponding to the model of the PD printer. For example, even when the user appoints the partitioned images in an order of A, B, C and D intending to print the multi-partitioned print shown in FIG. 6A, it may be performed to print the multi-partitioned print in the printing layout format as shown in FIG. 6B corresponding to the model of the PD printer.

In many cases, the PD printer layouts the images in the order of printing instruction transmitted from the digital still camera, so that it is necessary that the user becomes familiar with the printing layout format of the multi-partitioned print of the PD printer and appoints the images in a proper order depending on the inherent printing layout format of the multi-partitioned print of the PD printer so as to be printed the multi-partitioned print on which the images are laid out in the intended order of arrangement (printing layout). For example, when the user intends to print the multi-partitioned print in the printing layout shown in FIG. 7, it is necessary to instruct the images in an order of D, A, C and B from the digital still camera.

Furthermore, the printing manner of the multi-partitioned print depends on the printing layout format of the PD printer in the conventional PictBridge technology, so that there is a problem that the user cannot appoint the direction of the images on the multi-partitioned print. For example, even when the user intends to print the images on the multi-partitioned print in the printing manner shown in FIG. 8A, the multi-partitioned print may be printed in the printing manner shown in FIG. 8B, practically.

On the other hand, Japanese Laid-Open Patent Publication No. 2003-30670 shows that an image file including a plurality of image data selected by a user, an image processing control data for each image data and a layout format data is formed in the digital still camera side and outputted to the PD printer so as to print the plurality of images on a paper sheet in a printing layout corresponding to preference of the user. By such a configuration, a capacity of the image file for forming one print becomes much larger, so that a memory of large capacity is needed in each of the digital still camera and the PD printer, thereby causing increase in cost of the digital still camera and the PD printer.

Japanese Laid-Open Patent Publication No. 2003-264731 shows a camera having a function for automatically laying out and printing a plurality of still images. In particular, this camera is one combining a conventional camera using a silver halide film and the digital still camera that not only records the image on a silver halide film, but also takes the image with using an imaging device such as a CCD, and displays the image o an LCD. The case for laying out and printing a plurality of still images is assumed that the plurality of images are laid on a relatively large paper sheet equivalent to, for example, an album, so that a large image file of a large capacity is formed by editing the plurality of still images in the digital still camera. Therefore, a memory of large capacity is needed in each of the digital still camera and the PD printer, thereby causing increase in cost of the digital still camera and the PD printer.

Japanese Laid-Open Patent Publication No. the 2004-9388 shows a PD printer which can certify whether a digital still camera has a direct print function or not when the digital still camera is connected to the PD printer through a general purpose communication means such as a USB.

### SUMMARY OF THE INVENTION

The present invention is aimed to solve the above-mentioned problems of the conventional direct print system and to provide an improved direct print system that confirms whether both of a digital still camera and a PD printer can recognize predetermined commands which are originally set by a vendor or not when the digital still camera and the PD printer are connected through a USB cable, and can offer a printed result in complying with user's wish when both of the digital still camera and the PD printer can recognize the commands and when the user chooses a multi-partitioned print that a plurality of images is printed on a paper sheet as a printing format.

A direct print system in accordance with an aspect of the present invention is comprised of a digital still camera and a photo-direct printer which is to be connected to the digital still camera, enables to form an image by the photo-direct printer with using image data taken by and directly transmitted from the digital still camera. Both of the digital still camera and the photo-direct printer have a decoder and an encoder for commands of PictBridge format.

When the digital still camera and the photo-direct printer are connected through a USB (Universal Serial Bus), the digital still camera and the photo-direct printer transmit and receive predetermined commands written on lines of the PictBridge which are not recognized normally and written in XML (eXtensible Markup Language) tag format so as to confirm whether they can recognize the predetermined commands or not with each other.

When both of the digital still camera and the photo-direct printer can recognize the predetermined commands, optional information which is original of a vendor except commands defined in the PictBridge is transmitted with using the lines which are not recognized normally and written in the XML tag format.

By such a configuration, it is possible to confirm whether the digital still camera and the photo-direct (PD) printer can recognize the optional information which is original of the vendor except the commands defined in the PictBridge or not by transmitting and receiving the predetermined commands. When both of the digital still camera and the PD printer can recognize the predetermined commands, it is possible to transmit the optional information such as printing layout information of multi-partitioned print inherent to the PD printer from the PD printer to the digital still camera. Thus, a user can confirm the result of the multi-partitioned print before actually printing by displaying selected images in order of arrangement and directions on a display of the digital still camera based on the printing layout information transmitted from the PD printer. Alternatively, when at least one of the digital still camera and the PD printer cannot recognize the predetermined command, the command written on the lines of the PictBridge which are not recognized normally will be ignored, so that there is no problem.

A direct print system in accordance with another aspect of the present invention is comprised of a digital still camera and a photo-direct printer to be connected to the digital still camera, and directly transmitting digital still image data, information relating to printing format and instruction to perform printing operation from the digital still camera to the photo-direct printer. Both of the digital still camera and the photo-direct printer have a decoder and an encoder for commands of PictBridge format.

When the digital still camera and the photo-direct printer are connected through a USB (Universal Serial Bus), the digital still camera and the photo-direct printer transmit and receive predetermined commands written on lines of the PictBridge which are not recognized normally and written in XML tag format so as to confirm whether they can recognize the predetermined commands or not with each other.

When both of the digital still camera and the photo-direct printer can recognize the predetermined commands and a multi-partitioned print that a plurality of images are printed on a paper sheet is selected as the printing format, commands for appointing order of arrangement and directions of images to be printed as the multi-partitioned print are written on the lines of the PictBridge which are not recognized normally and written in the XML tag format and transmitting to the photo-direct printer with a command of the PictBridge format for performing the multi-partitioned print.

By such a configuration, when both of the digital still camera and the PD printer can recognize the commands written in the lines of the PictBridge which are not recognized normally, it is possible to appoint the order of arrangement and the directions of a plurality of images which are printed on a paper sheet as the multi-partitioned print from the digital still camera to the PD printer utilizing the lines of the PictBridge which are not recognized normally. Thus, it is possible to obtain a printed result satisfying a user's wish.

### BRIEF DESCRIPTION OF THE DRAWINGS

FIG. 1 is a view showing appearances of a digital still camera (DSC) and a photo-direct printer (PD printer) constituting a direct print system in accordance with the present invention;

FIG. 2 is an electric block diagram showing configurations of the digital still camera and the PD printer;

FIG. 3 is a block diagram showing communication protocol architecture of PictBridge adopted in the above direct print system;

FIG. 4 is a chart showing protocol of processes of confirmation and alteration of printing layout in the above direct print system;

FIG. 5 is a text showing an example of commands written in comment lines of the PictBridge;

FIGS. 6A and 6B are explanatory drawings showing a problem of multi-partitioned print in a conventional direct print system;

FIG. 7 is an explanatory drawing showing another problem of the multi-partitioned print in the conventional direct print system; and

FIGS. 8A and 8B are explanatory drawings showing still another problem of the multi-partitioned print in the conventional direct print system.

### DETAILED DESCRIPTION OF THE EMBODIMENT

The best modes and preferred embodiments of the present invention will be described hereinafter with reference to the attached figures. The present invention relates to a direct print system for printing a still image on a paper sheet by transmitting a digital still image data from a digital still camera (abbreviated as DSC in the figures) to a photo-direct printer (hereinafter abbreviated as PD printer in the description and figures). It is noted that the specific embodiments described below are not intended to cover the entire scope of the present invention, and hence the present invention is not limited to only the specific embodiments.

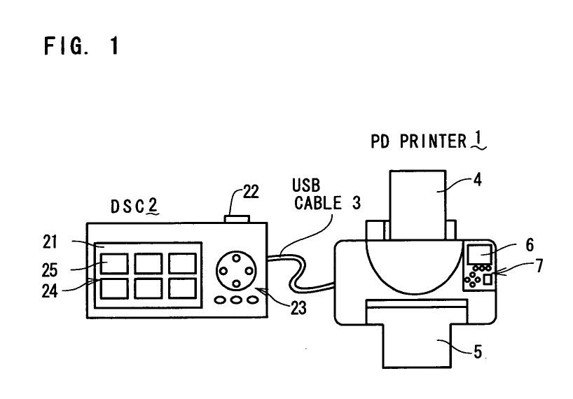

FIG. 1 shows appearances of a PD printer 1 and a digital still camera 2 which constitute a direct print system in accordance with an embodiment of the present invention. In this embodiment, the direct print system from the digital still camera 2 to the PD printer 1 is realized by using PictBridge technology. The PD printer 1 and the digital still camera 2 are connected through a USB (Universal Serial Bus) cable 3. As illustrated in the figure, the PD printer 1 is comprised of a paper feed tray 4 on which paper sheets to be used for printing an image with high image quality of photograph are disposed, an exit tray 5 on which printed paper sheets are disposed, an LCD (Liquid Crystal Display) unit 6 for displaying various kinds of messages and so on, and an operation panel 7 used for performing various kinds of operations.

On the other hand, the digital still camera 2 is comprised of an LCD monitor 21 and an operation unit 23 used for performing various operations which are arranged on a rear face thereof, and a shutter switch 22 arranged on a top face thereof. The LCD monitor 21 displays an image taken at that time by an imaging device 29 such as a CCD (Charge Coupled Device), a still image already taken by the imaging device 29 and memorized in a memory (hereinafter referred to photographed image), and a selection screen 24 used for selecting images to be printed and printing layout information received from the PD printer when multi-partitioned print that a plurality of images is printed on the same paper sheet is chosen. The selection screen 24 is a screen listing a plurality of the photographed images 25 in thumbnail size as illustrated in the figure for selecting at least one photographed image to be printed.

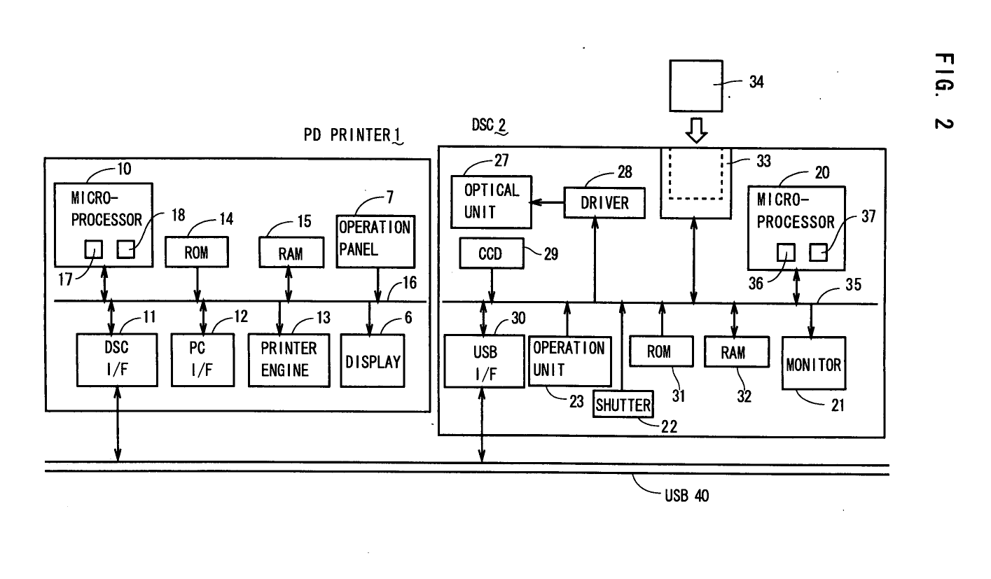

FIG. 2 shows an electric block diagram of the PD printer 1 and the digital still camera 2. The PD printer 1 comprises a microprocessor 10 serving as a printer controller for controlling the entire of the PD printer 1, an interface circuit 11 (DSC I/F) used to be connected with the digital still camera serving as a transmitter-receiver of the printer, an interface circuit 12 (PC I/F) used to be connected with a personal computer, a printing engine 13 for printing an image on a paper sheet with using an image data transmitted from the digital still camera 2 or the like, a ROM (Read Only Memory) 14 for memorizing control programs in which procedures in the microprocessor 10 and a font data are written, and a RAM (Random Access Memory) 15 for temporarily memorizing image data received from the digital still camera 2 or the like and printing layout information which will be described below, further to the above-mentioned LCD unit 6 and the operation panel 7. Data transmission among theses elements is performed through an internal bus 16. In addition, the microprocessor 10 has a decoder 17 and an encoder 18 of commands of PTP (Picture Transfer Protocol) format and the PictBridge format.

On the other hand, the digital still camera 2 comprises a microprocessor 20 serving as a camera controller for controlling the entire of the digital still camera 2, an optical unit 27 constituted by a lens and a driving system thereof, a driver 28 for controlling the optical system 27, an imaging device 29 such as the CCD, an interface circuit 30 in slave side of the USB (USB I/F) used to be connected with the PD printer 1 serving as a transmitter-receiver of the camera, a ROM 31 for memorizing control programs in which procedures in the microprocessor 20 are written, a RAM 32 for temporarily memorizing data such as the printing layout information, and a connector 33 to which a memory card 34 for memorizing the photographed image data is connected, further to the above-mentioned LCD monitor 21, the shutter switch 22 and the operation unit 23. Data transmission among theses elements is performed through an internal bus 35. In addition, the microprocessor 20 has a decoder 36 and an encoder 37 of commands of PTP format and PictBridge format. Data transmission between the digital still camera 2 and the PD printer 1 is performed through the interface circuit (USB I/F) 30, a USB 40 and the interface circuit (DSC I/F) 11.

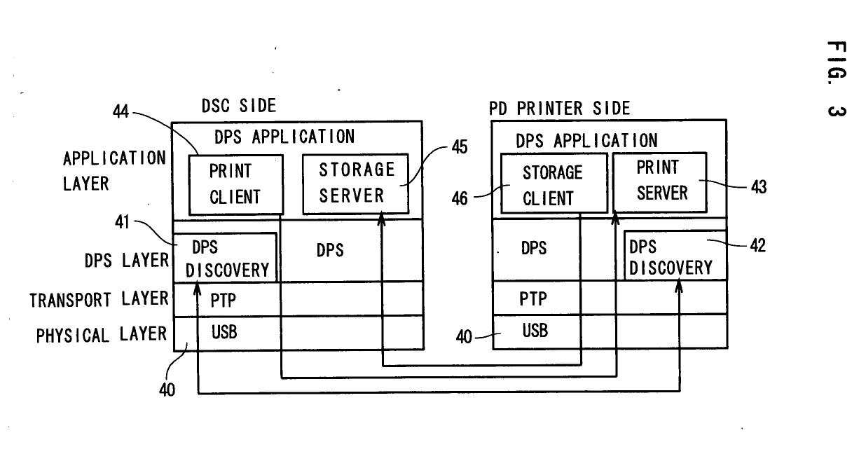

FIG. 3 shows communication protocol architecture of the PictBridge adopted in the direct print system. In the PictBridge, USB 40 is used as a physical layer, and PTP is used as an upper transport layer. As shown in the figure, a DPS (Digital Photo Solution) layer which is an additional conversion layer is further provided between the transport layer and an application layer. The DPS layer provides a mapping between the communication protocol of PTP and the DPS application. PictBridge is a technology that standardizes the interface protocol between the DPS layer and the application layer.

Subsequently, software components of the PictBridge will be described with reference to FIG. 3. The software component of the PictBridge has a Print Server 43, a Print Client 44, a Storage Server 45, and a Storage Client 46 existing in the application layer and DPS Discoveries 41 and 42 existing in the DPS layer. In the PictBridge, it is assumed that the printer requires the image data to the digital still camera when the printer performs the printing operation responding to a print requirement from the digital still camera. Thus, normally, a user does not aware the Storage Client 46. In the DPS application, each DPS operation is basically completed in sequences that the Server responds to requests from the Client, and then replies with results of the responses to the Client. Furthermore, each DPS event is completed in sequences that the Client responds to notifications issued from the Server, and then replies with confirmations of receipt to the Server.

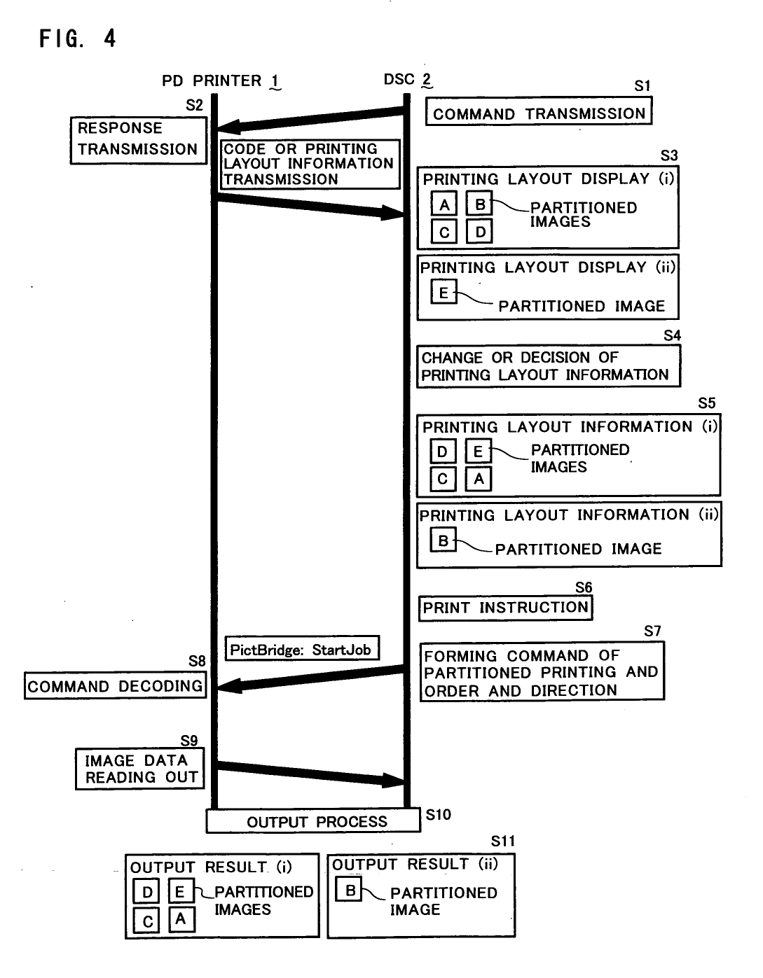

Subsequently, a multi-partitioned print in the direct print system in this embodiment is described with reference to FIG. 4.

When the digital still camera 2 is connected to the PD printer 1 via the USB cable 3, each of the microprocessor 10 of the PD printer 1 and the microprocessor 20 of the digital still camera 2 transmits and receives predetermined commands written on predetermined lines such as comment lines of the PictBridge which are not recognized normally and written in XML (eXtensible Markup Language) tag format (hereinafter referred as comment lines) so as to confirm whether the digital still camera 2 and the PD printer can recognize the predetermined command or not with each other.

Specifically, under an assumption that both of the digital still camera 2 and the PD printer 1 are matched with the PictBridge, when the digital still camera 2 and the PD printer 1 is connected through the USB cable 3, the microprocessor 20 of the digital still camera 2 writes a predetermined command for making the PD printer output a code identifying, for example, a model and a manufacturer thereof on a comment line of the PictBridge and outputs to the PD printer 1 (S1). When the PD printer 1 can recognize the predetermined command written on the comment line of the PictBridge, the microprocessor 10 of the PD printer 1 transmits a response corresponding to the predetermined-command to the digital still camera 2 (S2). The response is also written on a comment line of the PictBridge, and transmitted with the commands of the PictBridge.

On the other hand, when the PD printer 1 cannot recognize the predetermined command, the predetermined command written on the comment line of the PictBridge is usually ignored, and no response corresponding to the predetermined command is transmitted from the PD printer 1 to the digital still camera 2. Therefore, the microprocessor 20 of the digital still camera 2 can know whether the PD printer 1 connected thereto by the USB cable 3 is matched with this direct print system or not. As for the response to the predetermined command, it may be the printing layout information including a printing layout format which shows an order of a list of images inherent to the PD printer 1 other than the code identifying the model of the PD printer 1 in this embodiment. Alternatively, it may be a code for identifying a model and a vendor of the PD printer 1.

When the user inputs an instruction for printing a multi-partitioned print in 4-UP layout (layout for printing four images in 2×2 matrix on a paper sheet) from the operation unit 23, the microprocessor 20 of the digital still camera 2 displays the selection screen 24 including a plurality of the photographed images 25 on the LCD monitor 21, as shown in FIG. 2. Under this condition, the user selects the images A, B, C, D and E which are to be printed as the multi-partitioned print (hereinafter abbreviated as partitioned images) among the photographed images 25 displayed on the selection screen 24 and instructs to output image data of these partitioned images with using the operation unit 23. Since the printing layout information of the PD printer 1 is known from the response or the model of the PD printer 1 is identified by the response from the PD printer 1, the microprocessor 20 of the digital still camera 2 displays the photographed images 25 sequentially in the order of selection on the LCD monitor 21 at predetermined positions (order of arrangement) and directions following to the printing layout information inherent to the PD printer 1, as shown in FIG. 1 (S3).

At this time, the user can know the result of the multi-partitioned print before actually printed by the PD printer 1. If the position (order of arrangement) and/or the direction of each partitioned image displayed on the LCD monitor 21 is/are not satisfied, the user can input the instruction for changing the order of arrangement and/or the directions of the partitioned images with using the operation unit 23 (S4). When the order of arrangement and/or the directions of the partitioned images are changed, the microprocessor 20 changes the order of arrangement and/or the directions of the partitioned images responding to the instruction by the user and displays the changed partitioned images on the LCD monitor 21 again (S5).

When the user inputs an instruction for performing the multi-partitioned print with using the operation unit 23 (S6), the encoder 37 of the digital still camera 2 forms a command in compliance with the PictBridge format for printing the multi-partitioned print in 4-UP layout, writes a command to appoint the order of arrangement and the directions of the images to be printed on the comment lines of the PictBridge following to the order of arrangement and the directions of the partitioned images displayed on the LCD monitor 21 at that time. The command in compliance with the PictBridge is transmitted from the digital still camera 2 to the PD printer 1 through the interface circuit (USB I/F) 30 (S7).

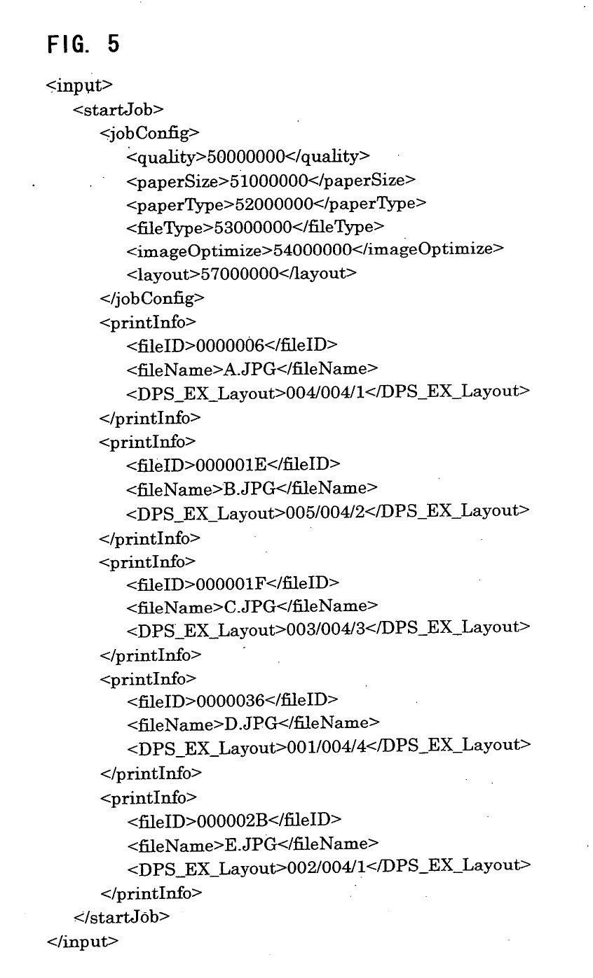

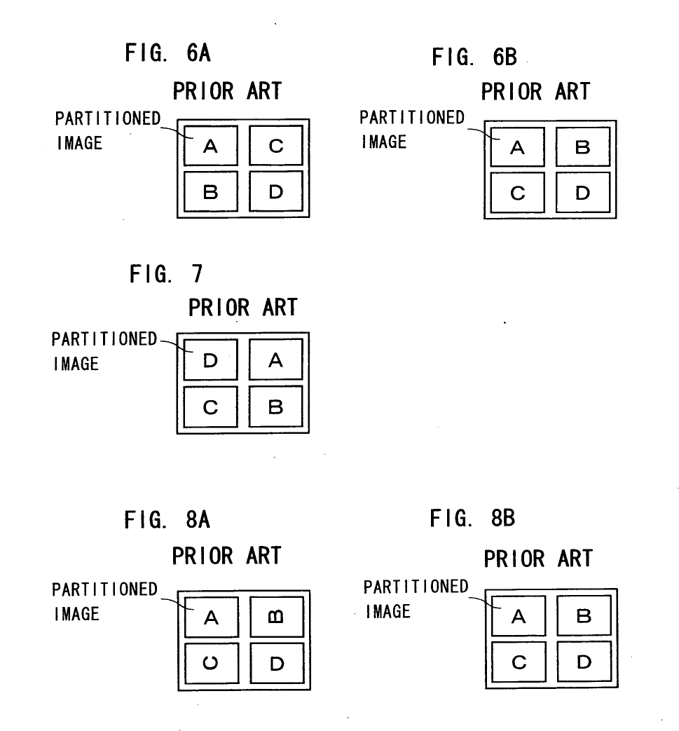

An example of the command (StartJob) in compliance with the PictBridge format to be transmitted to the PD printer 1 from the digital still camera 2 and the commands to appoint the order of arrangement and the directions of the images to be printed written on the comment lines is shown in FIG. 5. In FIG. 5, lines beginning with a tag of DPS_EX are the comment lines, the tag of DPS_EX Layout shows the command relating to the position (or the order of arrangement) and the direction of a partitioned image in the multi-partitioned print. In the StartJob command, it is appointed that the multi-partitioned prints are printed with using five image data having file names A.JPG, B.JPG, C.JPG, D.JPG, and E.JPG. Each strings 001/004, 002/004, 003/004, 004/004 and 005/004 on the line of DPS_EX_Layout shows an inherent position among four partitioned positions (order of arrangement) of the PD printer 1. In the example shown in FIG. 4, the position designated by the string 001 corresponds to the upper left position, the position designated by the string 002 corresponds to the upper right position, the position designated by the string 003 corresponds to the lower left position, and the position designated by the string 004 corresponds to the lower right position. The position designated by the string 005 corresponds to the upper left position on the second paper sheet. Furthermore, each string /1, /2, /3 and /4 at right side of the strings 001/004, 002/004, 003/004, 004/004 and 005/004 designates the direction of the partitioned image. The string /1 corresponds to a standard direction, the string /2 corresponds to a direction turned 90 degrees in counterclockwise direction from the standard direction, the string /3 corresponds to a direction turned 180 degrees in counterclockwise direction from the standard direction, and the string /4 corresponds to a direction turned 270 degrees in counterclockwise direction from the standard direction. The commands written on the comment lines of the PictBridge described above are examples, and it is needless to say that each vendor can freely define the commands.

When the microprocessor 10 of the PD printer 1 receives the command of the PictBridge format for performing the multi-partitioned print and the commands appointing the order of arrangement and the directions of the images to be printed written on the comment lines of the PictBridge from the digital still camera 2, it decodes the received commands with the decoder 17 of the PD printer 1 (S8). Then, the microprocessor 10 of the PD printer 1 serially reads out the digital still image data from the memory card 34 through the interface (I/F) 11, the USB 40 and the interface (I/F) 30 following to the order of arrangement appointed by the commands written on the comment lines of the PictBridge (S9). Subsequently, the microprocessor 10 forms a printing data for printing the multi-partitioned print with the digital still image data readout from the memory card 34, in which the partitioned images are laid out in the order of arrangement and in the directions appointed by the commands written on the comment lines of the PictBridge, and outputs the printing data to the printing engine 13 (S10). The printing engine 13 prints a plurality of images selected by the user on a paper sheet with using the outputted printing data in the appointed order of arrangement and in the appointed directions (S11).

As mentioned above, the digital still camera 2 and the PD printer 1 of the direct print system in accordance with this embodiment respectively have the decoder 17, 36 and the encoder 18, 37 of the commands of the PictBridge format, and when digital still camera 2 is connected to the PD printer 1 via the USB 40, the predetermined commands written on the comment lines of the PictBridge are transmitted and received between them so as to confirm whether they can recognize the predetermined commands or not. When both of the digital still camera 2 and the PD printer 1 can recognize the predetermined commands, the optional information which is original of each vendor except the commands defined in the PictBridge technology, specifically, the order of arrangement and the direction of the selected images in the multi-partitioned print can be appointed utilizing the comment lines of the PictBridge. Thus, the user can obtain a result of the multi-partitioned print which satisfies the user's wish.

Furthermore, only the information, which appoints file names memorizing the data of images to be printed in the multi-partitioned print, the order of arrangement and the directions of the images, is transmitted to the PD printer 1 from the digital still camera 2. The, the PD printer 1 accesses the memory card 34 installed in the digital still camera 2 for serially reading out the image data in the order of arrangement, and forms the printing data for one sheet of the multi-partitioned print by performing the image processing such as pixel skipping to the image data readout from the memory card 34. Since no edition of a plurality of the image data is performed in the digital still camera 2, it is no need to upsize the capacity of the memory of the digital still camera 2. Furthermore, the PD printer 1 does not process a plurality of the image data simultaneously, so that it is no need to upsize the capacity of the memory of the PD printer 1, too. As a result, it is possible to prevent the increase of costs of the digital still camera 2 and the PD printer 1.

In addition, the present invention is not limited to the above-mentioned embodiment, and it is possible to modify in various manners. For example, the example for printing the multi-partitioned print in 4-UP layout is described in the above-mentioned embodiment. The layout for the multi-partitioned print applicable of the present invention, however, is not limited to the example, and 2-Up layout (1×2 or 2×1) or 8-UP layout (2×4 or 4×2) may be adopted. Still furthermore, as for the present invention, it is sufficient that both of the digital still camera and the PD printer can recognize the predetermined commands written on the comment lines of the PictBridge, and the commands appointing the order of arrangement and the directions of the images to be printed as the multi-partitioned print is written on the comment lines of the PictBridge and transmitted to the PD printer from the digital still camera with the command of PictBridge format for instructing the multi-partitioned print, when the multi-partitioned print is selected for printing a plurality of images are printed on the same paper sheet.

Furthermore, the direct print system in accordance with the present invention is sufficient to be comprised of a digital still camera and a photo-direct printer connected to the digital still camera, and forming an image by the photo-direct printer with using image data taken by the digital still camera. Both of the digital still camera and the photo-direct printer have a decoder and an encoder for commands of PictBridge format. When the digital still camera and the photo-direct printer are connected via a USB (Universal Serial Bus), the digital still camera and the photo-direct printer transmit and receive predetermined commands written on lines of the PictBridge which are not recognized normally and written in XML tag format so as to confirm whether they can recognize the predetermined commands or not with each other. And, when both of the digital still camera and the photo-direct printer can recognize the predetermined commands, optional information which is original of a vendor except command defined in the PictBridge is transmitted with using the lines which are not recognized normally and written in the XML tag format.

Since both of the digital still camera and the photo-direct printer can recognize predetermined commands written on lines of the PictBridge which are not recognized normally and written in XML tag format, it is possible to transmit and receive the commands originally set by the vendor(s) of the digital still camera and the PD printer except the commands defined in the PictBridge technology between the digital still camera and the PD printer. For example, when the user choose the multi-partitioned print (layout print) that a plurality of images are printed on a paper sheet, it is possible to appoint the order of arrangement (position on the partitioned areas on the paper sheet) and the direction of each image on the paper sheet following to the user's wish.

It is preferable that the optional information includes information relating to printing format and appointment for performing printing operation. By such a configuration, it is possible to input various instructions, such as printing format, order of arrangement and directions of the images to be printed as multi-partitioned print to the PD printer from the digital still camera by the user.

It is further preferable that the optional information transmitted from the photo-direct printer to the digital still camera includes printing layout information of multi-partitioned print that a plurality of images are printed on a paper sheet, which is inherent to the photo-direct printer. By such a configuration, the user can confirm the multi-partitioned print before it is actually printed by the PD printer.

It is still further preferable that the optional information transmitted from the digital still camera to the photo-direct printer includes file names of data, order of arrangement and directions of images to be printed, when the multi-partitioned print is selected by a user as the printing format. By such a configuration, it is possible that the PD printer can form a printing data with using digital still image data readout from a memory of the digital still camera and the order of arrangement and directions of images to be printed. As a result, a capacity of a memory such as a RAM of the digital still camera, which temporarily memorizes the digital still image data while the image data edition, can be reduced.

Alternatively, it is preferable that when the photo-direct printer receives the predetermined command transmitted from the digital camera, the photo-direct printer outputs a code identifying a model and a manufacturer. By such a configuration, it is possible to confirm the model of the PD printer in the digital still camera side.

It is further preferable that the digital still camera further has a memory for memorizing digital still images and printing layout information with respect to a plurality of models of photo-direct printers, and a display for displaying an image to be printed. When multi-partitioned print that a plurality of images are printed on a paper sheet is selected as printing format and a plurality of images to be printed as the multi-partitioned print by a user, the digital still camera reads out printing layout information of multi-partitioned print which is inherent to the photo-direct printer from the memory based on the code transmitted from the photo-direct printer, and displays the selected images on the display in order of arrangement and directions based on the printing layout information. By such a configuration, it is possible to confirm the result of multi-partitioned print on the display of the digital still camera before actually printing the multi-partitioned print by the PD printer.

It is still further preferable that the digital still camera further has an operation unit for inputting instructions; and when the user changes the order of arrangement and/or the direction of at least one image, the digital still camera displays the selected images on the display again in changed order of arrangement and/or directions based on instruction by the user. By such a configuration, if the result of the multi-partitioned print cannot satisfy the user's wish, it is possible to change the order of arrangement and/or the directions of the images.

It is still further preferable that when the user inputs an instruction for performing printing operation, the digital still camera outputs file names, order of arrangement and directions of the images displayed on the display at a time when the instruction for performing printing operation is inputted to the photo-direct printer. By such a configuration, it is possible to form the multi-partitioned print on which the selected images are printed in the order of arrangement and the directions following to the user's wish.

It is still further preferable that when the photo-direct printer receives the instruction for performing printing operation, and the file names, the order of arrangement and the directions of the images to be printed as the multi-partitioned print, the photo-direct printer reads out digital still image data of the images to be printed from the memory of the digital still camera, forms a printing data using the digital still image data and based on the order of arrangement and the directions of the images and the printing layout information of the multi-partitioned print, and prints a multi-partitioned print on a paper sheet using the printing data. By such a configuration, it is possible that the PD printer can form a printing data with using digital still image data readout from a memory of the digital still camera and the order of arrangement and directions of images to be printed. As a result, a capacity of a memory such as a RAM of the digital still camera, which temporarily memorizes the digital still image data while the image data edition, can be reduced.

Alternatively, it is preferable that the digital still camera further has a memory for memorizing digital still image data and a display for displaying an image to be printed; when the photo-direct printer receives the predetermined command transmitted from the digital camera, the photo-direct printer outputs printing layout information inherent to the photo-direct printer. When multi-partitioned print that a plurality of images are printed on a paper sheet is selected as printing format and a plurality of images to be printed as the multi-partitioned print by a user, the digital still camera displays the selected images on the display in order of arrangement and directions based on the printing layout information outputted from the photo-direct printer. By such a configuration, it is possible to confirm the result of multi-partitioned print on the display of the digital still camera before actually printing the multi-partitioned print by the PD printer.

This application is based on Japanese patent application 2004-273630 filed Sep. 21, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A direct print system comprised of a digital still camera and a photo-direct printer connected to the digital still camera, and forming an image by the photo-direct printer with using image data taken by the digital still camera, wherein
both of the digital still camera and the photo-direct printer have a decoder and an encoder for commands of PictBridge format;
when the digital still camera and the photo-direct printer are connected via a USB (Universal Serial Bus), the digital still camera and the photo-direct printer transmit and receive predetermined commands written on lines of the PictBridge which are not recognized normally and written in XML tag format so as to confirm whether they can recognize the predetermined commands or not with each other; and
when both of the digital still camera and the photo-direct printer can recognize the predetermined commands, optional information which is original of a vendor except command defined in the PictBridge is transmitted with using the lines which are not recognized normally and written in the XML tag format.

2. The direct print system in accordance with claim 1, wherein
the optional information includes information relating to printing format and appointment for performing printing operation.

3. The direct print system in accordance with claim 2, wherein
the optional information transmitted from the photo-direct printer to the digital still camera includes printing layout information of multi-partitioned print that a plurality of images are printed on a paper sheet, which is inherent to the photo-direct printer.

4. The direct print system in accordance with claim 3, wherein
the optional information transmitted from the digital still camera to the photo-direct printer includes file names of data, order of arrangement and directions of images to be printed, when the multi-partitioned print is selected by a user as the printing format.

5. The direct print system in accordance with claim 1, wherein
when the photo-direct printer receives the predetermined command transmitted from the digital camera, the photo-direct printer outputs a code identifying a model and a manufacturer.

6. The direct print system in accordance with claim 5, wherein
the digital still camera further has a memory for memorizing digital still images and printing layout information with respect to a plurality of models of photo-direct printers, and a display for displaying an image to be printed; and
when multi-partitioned print that a plurality of images are printed on a paper sheet is selected as printing format and a plurality of images to be printed as the multi-partitioned print by a user,
the digital still camera reads out printing layout information of multi-partitioned print which is inherent to the photo-direct printer from the memory based on the code transmitted from the photo-direct printer, and displays the selected images on the display in order of arrangement and directions based on the printing layout information.

7. The direct print system in accordance with claim 6, wherein
the digital still camera further has an operation unit for inputting instructions; and
when the user changes the order of arrangement and/or the direction of at least one image, the digital still camera displays the selected images on the display again in changed order of arrangement and/or directions based on instruction by the user.

8. The direct print system in accordance with claim 7, wherein
when the user inputs an instruction for performing printing operation, the digital still camera outputs file names, order of arrangement and directions of the images displayed on the display at a time when the instruction for performing printing operation is inputted to the photo-direct printer.

9. The direct print system in accordance with claim 8, wherein
when the photo-direct printer receives the instruction for performing printing operation, and the file names, the order of arrangement and the directions of the images to be printed as the multi-partitioned print,
the photo-direct printer reads out digital still image data of the images to be printed from the memory of the digital still camera, forms a printing data using the digital still image data and based on the order of arrangement and the directions of the images and the printing layout information of the multi-partitioned print, and prints a multi-partitioned print on a paper sheet using the printing data.

10. The direct print system in accordance with claim 1, wherein
the digital still camera further has a memory for memorizing digital still image data and a display for displaying an image to be printed; and
when the photo-direct printer receives the predetermined command transmitted from the digital camera, the photo-direct printer outputs printing layout information inherent to the photo-direct printer;
when multi-partitioned print that a plurality of images are printed on a paper sheet is selected as printing format and a plurality of images to be printed as the multi-partitioned print by a user,
the digital still camera displays the selected images on the display in order of arrangement and directions based on the printing layout information outputted from the photo-direct printer.

11. The direct print system in accordance with claim 10, wherein
the digital still camera further has an operation unit for inputting instructions; and
when the user changes the order of arrangement and/or the direction of at least one image, the digital still camera displays the selected images on the display again in changed order of arrangement and/or directions based on instruction by the user.

12. The direct print system in accordance with claim 11, wherein
when the user inputs an instruction for performing printing operation, the digital still camera outputs file names, order of arrangement and directions of the images displayed on the display at a time when the instruction for performing printing operation is inputted to the photo-direct printer.

13. The direct print system in accordance with claim 12, wherein
when the photo-direct printer receives the instruction for performing printing operation, and the file names, the order of arrangement and the directions of the images to be printed as the multi-partitioned print,
the photo-direct printer reads out digital still image data of the images to be printed from the memory of the digital still camera, forms a printing data using the digital still image data and based on the order of arrangement and the directions of the images and the printing layout information of the multi-partitioned print, and prints a multi-partitioned print on a paper sheet using the printing data.

14. A direct print system comprised of a digital still camera and a photo-direct printer connected to the digital still camera, and directly transmitting digital still image data, information relating to printing format and instruction to perform printing operation from the digital still camera to the photo-direct printer, wherein
both of the digital still camera and the photo-direct printer have a decoder and an encoder for commands of PictBridge format;
when the digital still camera and the photo-direct printer are connected via a USB (Universal Serial Bus), the digital still camera and the photo-direct printer transmit and receive predetermined commands written on lines of the PictBridge which are not recognized normally and written in XML tag format so as to confirm whether they can recognize the predetermined commands or not with each other; and
when both of the digital still camera and the photo-direct printer can recognize the predetermined commands and multi-partitioned print that a plurality of images are printed on a paper sheet is selected as the printing format, commands for appointing order of arrangement and directions of images to be printed as the multi-partitioned print are written on the lines of the PictBridge which are not recognized normally and written in the XML tag format and transmitting to the photo-direct printer with a command of the PictBridge format for performing the multi-partitioned print.
